(19) United States
(12) Patent Application Publication
(10) Pub. No.: US 2016/0356008 A1
(43) Pub. Date: Dec. 8, 2016

(54) Pneumatic pavement joint cleaning system

(71) Applicant: Pave Tech, Inc., Prior Lake, MN (US)

(72) Inventor: Stephen Jones, Prior Lake, MN (US)

(21) Appl. No.: 15/170,539

(22) Filed: Jun. 1, 2016

Related U.S. Application Data
(60) Provisional application No. 62/171,123, filed on Jun. 4, 2015.

(51) Int. Cl. E01H 1/08; B08B 5/02; B08B 5/04; A47L 9/00; B08B 15/00; A47L 9/08; A47L 9/24; A47L 5/14; B08B 3/02

(52) U.S. Cl. CPC E01H 1/0863; E01H 1/0872; A47L 5/14; B08B 5/02; B08B 5/04; B08B 3/024; B08B 15/00; A47L 9/08; A47L 9/24; A47L 9/009

(57) ABSTRACT

A pneumatic cleaning system for pavement joints controlled and driven by a motor. A wheeled housing carries a nozzle system where a stream of pressurized or forced air is directed through rotating nozzles to clean the joint surfaces. The RPM of the motor are selectively controlled by actuation of a throttle by the operator, and allows the operator to selectively control the rate of rotation of the nozzles are required by the state of the surface to be cleaned. A vacuum is further positioned to remove the debris dislodged by the pneumatic system. A brush or skirt component further loosens debris for removal and contains the debris within the cleaning area for controlled removal by vacuum suction. A frame may be operably connected to the cleaning base allowing the operator to stand/walk within the frame when moving the cleaning base and where the frame is a support for at least a vacuum hose.

### CROSS-REFERENCE TO RELATED APPLICATION

The present application is based on and claims the benefit of U.S. provisional patent applications Ser. No. 62/171,123, filed Jun. 4, 2015, the content of which is hereby incorporated by reference in its entirety.

### BACKGROUND

Various outdoor surfaces comprise networks of pavers positioned in selected areas and according to selected designs. Pavers are generally segmental pieces of concrete, clay, or like materials and having various shapes which allow a series of pavers to be laid and interconnected to form a substantially continuous surface for walking, driving or otherwise supporting various activities. When pavers are laid to form a surface, the pavers are spaced from each other. The spaces are referred to as joints and extend around the perimeter of each paver and exist substantially along the perimeters between any two adjacent pavers. The joints allow the shape of the paver to be discernible and provide a pattern to the paver surface. These joints are not normally grouted nor is adhesive typically used to lay and secure the pavers.

In a typical paver arrangement, sand is placed in the spacing between the pavers. The sand holds the pavers together in the pattern selected. In essence the individual pavers float but are secured in this sand matrix.

Such paver surfaces, however, are not amenable to water drainage. Water typically flows along the top surface of the pavers and joints, causing excessive runoff in many situations. To solve this problem, a drainage system has been developed. The pavers are initially positioned on a surface under which water may flow. Instead of sand being placed in the paver joints, a crushed rocks used. The crushed rock permits water to drain between the pavers, through the paver joints, and into the drainage system below.

Such drainage systems have worked well. However, over time, fine debris may accumulate in and on these joints and even form a crust. The crust becomes water impermeable, thereby negating the water permeability of the joint. Further, pressure washing drives silt deeper into the surface of the crushed rock, where it cannot be removed.

Prior art methods of cleaning these paver joints are labor intensive and time consuming. Such methods generally comprise pressure washing with water the joint area. Pressure washing although may remove the crust, results in the production of a sludge. The removal of the sludge/silt requires additional labor. In addition, the sludge may be considered a hazardous waste and as a result has to be disposed of in compliance with certain government regulations relating to hazardous waste. This compliant disposal/removal adds to the cost of the removal of the crust. Presently there is no effective way to efficiently clean paver joints over any large surface area.

### SUMMARY

One aspect of the present disclosure relates to a pneumatic cleaning system for a surface comprising pavers. More specifically, the system is configured to use air flow to effectively clean the joints or grouted areas between the pavers. The system does not require water flow for debris removal. The pneumatic system may be controlled and driven, for example, by a gas engine or other motor. The pneumatic cleaning system utilizes a stream of pressurized or forced air to clean the joint sections of the paver surfaces or pathways formed by positioning of various pavers. A mobile or wheeled device comprising a cleaning base has at least one nozzle and for example, two opposing nozzles positioned to hover and rotate above a paver and joint surface. The nozzle(s) is/are passed over the surface and the air flow and circulation is controlled by the speed of rotation of the nozzle(s) to clean the surface. The nozzles direct forced air to the surface and the speed of rotation of the nozzles are controlled by selectively adjusting the RPM of the motor or engine. Thus, an operator can selectively adjust the air flow in the system over the surface based at least in part on the state of the surface to be cleaned.

In one embodiment, a vacuum port is further positioned on the wheeled device and positioned near the surface. The vacuum port or ports is/are configured to remove the debris that is loosened by the pressurized air from the nozzle(s). The vacuum thus lifts the loosened debris off of the paver joints or surface to be cleaned and removes the debris from the area. A second vacuum port may also be positioned on the wheeled device, the second vacuum port, for example, being positioned on an opposing side of the device to increase vacuum flow from under the body of the wheeled device. The system may further comprise a brush or skirt component positioned along the outer perimeter of the wheeled device to retain the loosened debris in the area being cleaned (underneath the wheeled device) so that the debris may be lifted and removed by the vacuum system. The system may also clean various surfaces including grouted areas, pavements, brick surfaces and the like, without water, such as parking lots or ramps.

Another aspect of the present disclosure relates to incorporating a liquid flow into the pressurized air flow. A liquid for cleaning, for example, water, may be incorporated into the system such that the system is configured for connection to a water supply source. A water and compressed air mixture may be ejected from the nozzles as described above with hydro force control being connected to the air supply or may additionally or alternatively be incorporated into a selectively usable wand. As used throughout this disclosure, the term “hydro force” means pneumatic power or the power of compressed air flow and water to produce a turbulent air/water jet stream. Thus, the user has the option to use only compressed air or to use the combination of water and compressed air for cleaning. The water incorporated in the compressed air flow may act as a solvent and/or cleaning medium for the surfaces to be cleaned. The hydro force is incorporated into a user interface, which may be a handle and barrel which are connected via tubing to an outlet or nozzle. The handle comprising the barrel is also adapted with two inlet sections, one for connection to first hose for providing compressed air from its source and a second inlet for connection to a second hose for providing water from the water source. The barrel is also connected to an outlet tube for directing the water and compressed air mixture to an exit orifice. The delivery of the compressed air through the handle to the barrel to the outlet hose or tube which terminates in a nozzle, is controlled by a trigger or switch operable from the handle. A valve is positioned in the barrel to control the water flow through the handle to the outlet hose or tube and to the exit orifice, which may be the nozzles positioned on the rotatable wand or may be another independently movable or positionable nozzle. When the trigger is pulled, compressed air flows through the handle and pushes the valve to an open position, which allows a flow of water to enter the barrel. As the water and compressed air are directed to the barrel, the water and air mix in the barrel and travel through the hose or tube to the nozzle as a jet of compressed air and water. Thus, the compressed air is turbulently mixed with a small amount of water to provide a hydro force jet for cleaning.

Yet another aspect of the present disclosure relates to a frame component that may be operably connected to the cleaning base section. The frame carries one or more vacuum hoses and/or pressurized air lines to the wheeled device while permitting the operator to be positioned behind the device so that the device can be pushed/controlled by the operator.

The frame is configured with a shape to allow an operator to essentially stand and move within the frame when moving the cleaning base. The frame further acts a support section for a vacuum hose which is connected to the vacuum port. The frame as configured according to this disclosure enhances the portability of the system. For example, the frame may be configured as “H” shaped in a first section and then “A” shaped in a second integral section at the back end of the frame. Such a configuration makes the frame sufficiently compact while providing a space between frame supports for the operator to stand and walk while controlling the cleaning system. The frame may be supported by a caster(s) or wheel at the tail end (not shown).

### BRIEF DESCRIPTION OF THE DRAWINGS

FIG. 1 is a perspective view of a pneumatic paver joint cleaning system.

FIG. 2 is a top perspective view a wheeled housing of the cleaning system.

FIG. 3 is a top view of the wheeled housing of the cleaning system.

FIG. 4 is a cross-sectional side view of the housing of the cleaning system.

FIG. 5A is a side view of a dual pulley system of the cleaning system where the pulley is illustrated as isolated from the wheeled housing for clarity.

FIG. 5B is a side perspective view of the isolated dual pulley system of the cleaning system.

FIG. 6 is a side view of the joint cleaning system illustrating an adjustable handle.

### DETAILED DESCRIPTION

The present disclosure relates to a portable pneumatic cleaning system for outdoor surfaces. The system may effectively be used to clean a variety of surfaces, which may for example comprise pavers or paving stones of brick, stone, tile, ceramic or other segmental materials. Surfaces may also include concrete and/or paved surfaces that may have “pavement joints” for cleaning. The surfaces described previously, also referred to exterior flooring may comprise patterns of pavers selectively laid on a ground surface to form pathways, drive ways, roads, patios, walkways and other outdoor platforms and the joints formed between the pavers when foaming the pattern. The joints are generally small open spaces or lengths surrounding each paver and present between each two adjacent pavers. The joints may be filled with a sand component, and in the case of joints that permit water to drain through, crushed rock.

The cleaning system of the present disclosure removes debris that has accumulated on or in the joints. Such debris accumulates over time and may include organic or inorganic debris such as fine sand or pebbles, grit, dirt, bits of plant matter such as bits of foliage, bark, or wood. Over time, the debris may form a hard crust on the joint surface which becomes impermeable to water, thereby negating the drainage characteristic of the joint.

The pneumatic cleaning system of the present disclosure removes the surface debris from the joints between pavers with or without the use of water or other wet cleaning solutions. The system may instead utilize only air (or other types of gas) flow under pressure to dislodge and clean debris from the paved surface and the corresponding paver/pavement joints. The system may also incorporate a small amount of liquid flow into the air flow for further cleaning areas that may require extra cleaning effort. The system also includes a corresponding vacuum flow component configured to remove the dislodged debris from the area. The system may further comprise a brush component that contains the debris within the cleaning area for vacuum removal or otherwise further loosening debris.

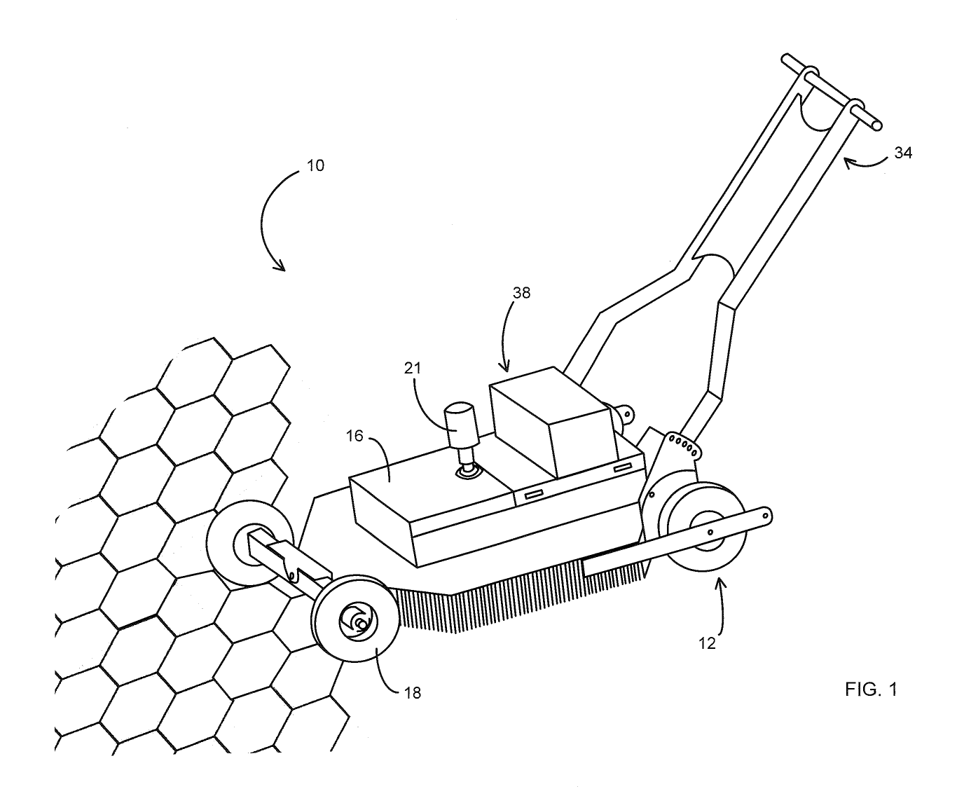

The pneumatic paver joint cleaning system is illustrated generally at 10 in FIG. 1 and comprises a cleaning base 12 and a frame 50. The cleaning base 12 is a wheeled housing providing a covered cleaning area. The wheeled housing 16 comprises a cover that is configured to contain dislodged debris for subsequent vacuum removal and to support operational components of the system 10. The wheeled housing 16 comprises casters and wheel pairs or opposing pairs of wheels 18. The wheels 18 allow the system to be easily portable movable over the cleaning surface. The housing 16 further includes an aperture 20 allowing for sealed connection with a hose or tube 22. The aperture 20 may be fitted with a pipe coupling 21 which allows for connection of the tube 22 to the system and allows for providing air, gas (or in some embodiments air/gas and water) into the housing 16 to the nozzle system 24 which may comprise one or more nozzles to deliver air or gas under pressure to the system 10 from a pressurized air source (not shown). The pressurized or pneumatic air source may be present on a truck or movable cart for providing air or gas under pressure to the system 10 while being portable with the system 10. Thus, the system 10 can be used to clean surfaces of varying sizes.

A nozzle system 24 for distributing the air over the joints for cleaning is rotatably secured to the upper surface of the housing 16. The nozzle system 24 thus hovers slightly over the surface to be cleaned as the wheels extend to engage with the ground surface. The nozzle system 24, having one nozzle or a plurality of individual nozzles that moved in a cooperating manner, is operably connected to the tube 22 such that air flow can be directed to and through the nozzle system 24. The nozzle system is preferably positioned to extend a sufficient distance toward the ground or pavement/paved surface but not so far as to be in contact with the pavement engaging surface. Thus, the nozzle system 24 is freely rotatable.

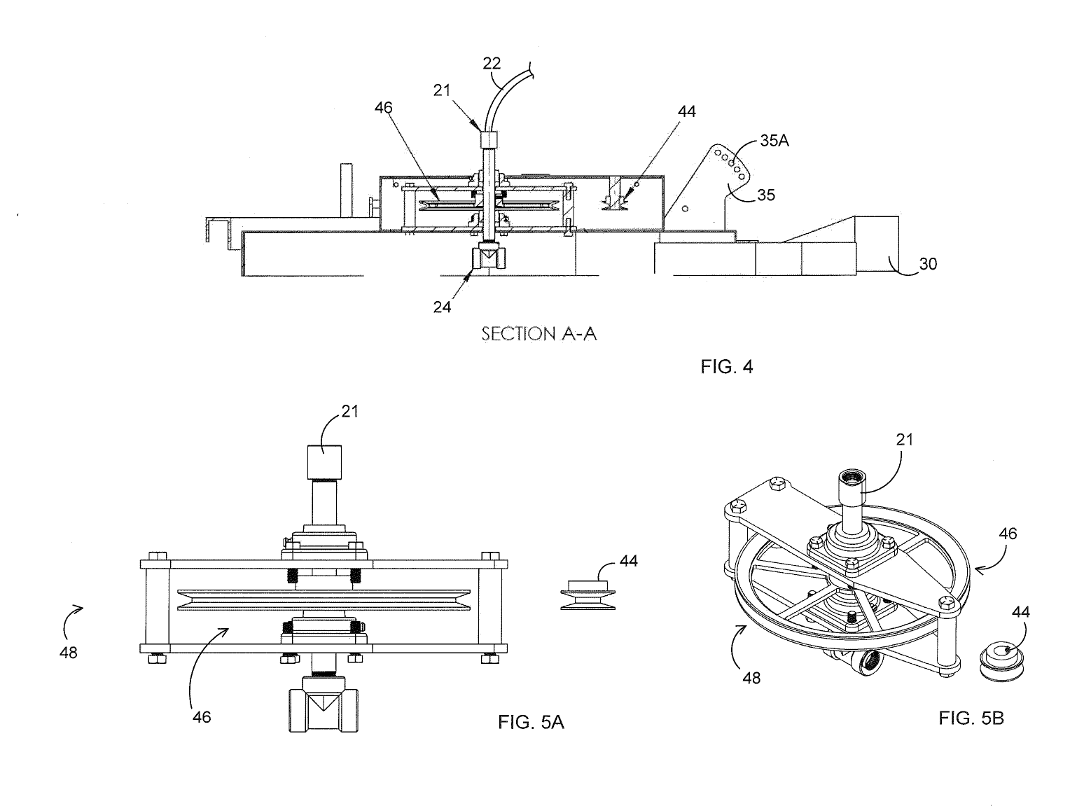

As illustrated in FIG. 4, the nozzle system 24 comprises a rotatable shaft or wand 26 positioned generally horizontally between the upper surface of the housing 16 and the paver and joint surface. The shaft 26 rotates in a generally horizontal plane, and comprises downwardly oriented nozzles 28 positioned at the opposing terminal ends of the shaft 26. The nozzles 28 are configured to receive the air (or other gas) flow under pressure and to direct the air flow downwardly to the paver and/or paver joint surfaces. The nozzles 28 also then are configured to rotate horizontally with the shaft 26 within the covered cleaning area to provide a cleaning area that is determined by the length of the shaft 26 and thus the position of the nozzles 28. The rotational speed of the nozzle(s) allows the nozzles and forced air to clean the surface and joints. The nozzles 28 direct forced air (and/or forced air with a minimal amount of water) to the surface and joints and the controllable variable speed of rotation of the nozzles enhances and controls cleaning of the surface and the joints. The housing is of sufficient size to cover the cleaning area defined by the rotating nozzles 28. Further, the movement of the system 10 along the surface during operation extends the cleaning surface area. The area that can be cleaned may not be bounded or otherwise limited, as the system 10 is configured for movement in various directions over the surface.

The system 10 further comprises at least one connection to a vacuum source (not shown) and at least one vacuum hose 30 connected via an outlet in the housing. The vacuum hose 30 connects the vacuum source to an inner area within or below the housing 16. The vacuum hose or tube 30 may be, for example, a flexible but durable hose connecting the vacuum source to the inlet port of system 10. It should be understood that one or a plurality of inlet ports can be introduced into the housing for removal of debris. Additional vacuum hoses and vacuum ports can be incorporated as necessitated by the power of the vacuum source. The vacuum source may also be carried by the truck or portable cart, allowing the system to remain portable with the operator. The length of the vacuum hose (and the length of the pneumatic hose) are of a length sufficient to allow the operator of the system 10 to move with the system without requiring constant movement of the truck or cart when cleaning.

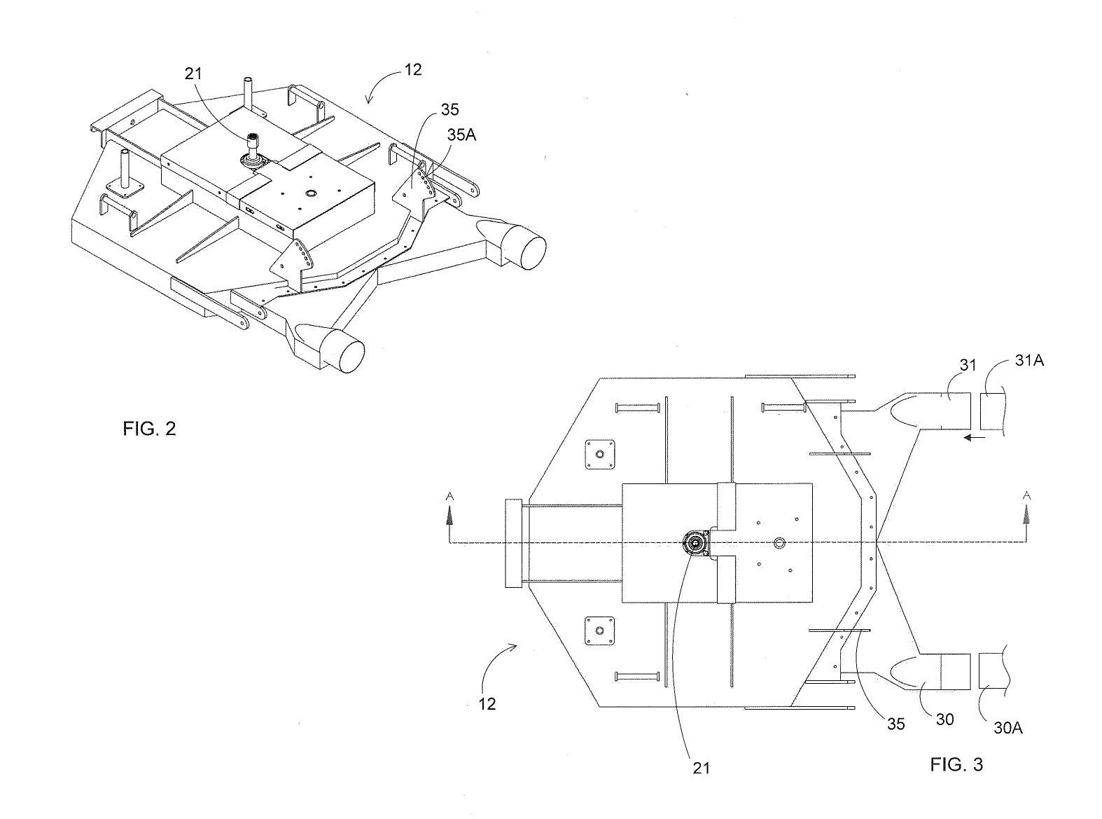

The end of the vacuum hose 30 connected to the housing 16 has a vacuum port or outlet 30B that may be positioned at the rear of the housing to direct the vacuum suction under the housing 16 or near the housing 16 to remove the air dislodged debris. As illustrated in FIGS. 2-3, a second vacuum hose 31 may be connected to the housing 16 at a second vacuum port or outlet 31A. The one or more outlets may be a vacuum port where the vacuum port is positioned in or near the housing and allows for removal of debris from the ground below the housing 16. For example. The one or more outlets/vacuum ports may be positioned near the rear or back side of the housing. This allows the outlet to suck up and provide a path for removal of debris dislodged by the air flow or the flow of air and water as the system is pushed forward or backward over the paver surface. The operator may control the movement of the vacuum hoses to remove debris as the debris is dislodged from the joints and settled on the paver surface by moving the base 12 to pass over the cleaning area.

The housing 16 may be further adapted with side walls comprising bristles 32 or brush like components extending downwardly from the housing along the side lengths of the base 12 and to engage with the ground surface or pavers. The brushes 32 are configured to prevent the debris from blowing away and contain the debris under the housing so that the debris can be removed by moving the vacuum port(s) over the loose debris.

The base 12 further comprises an upwardly extending handle 34 which extends sufficiently upwardly at a slight incline which allows the handle 34 to be used not only for steering the base 12 during movement and cleaning, but also to support a throttle 36 for controlling the rotational speed of the air nozzles during cleaning. The handle position (e.g., height or angle/incline) can be manually adjusted as illustrated by heights 34A, 34B, and 34C as non-limiting examples in FIG. 6. The handle 34 is adjustable by way of a securable connection between outwardly protruding tabs 35 on the lower side arms of the handle (and extending upwardly from the base 12) and a series of apertures 35A extending upwardly from the rear of the base for positioning the handle at one of a plurality of inclines. The throttle 36 is operably connected to control a motor 38 which may also be positioned on the housing 16. The motor 38 is configured for controlling the rotation of the nozzles 28. The speed or revolutions per minute (RPM) of the motor can be selectively controlled via actuation of the throttle 36. In some embodiments, the motor may be a gas engine. Changing the RPM of the motor allows the operator to continue cleaning while adjusting the rotation speed of the nozzles 28, rather than adjusting the pace in which the operator moves the base 12.

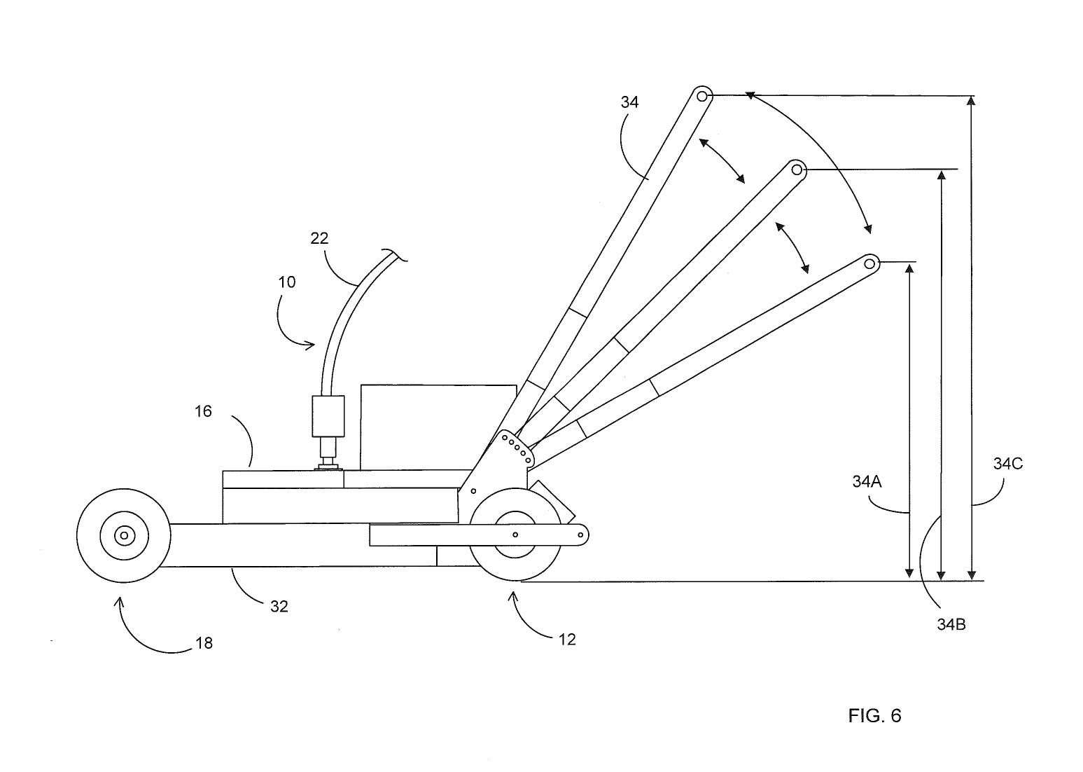

As illustrated in FIGS. 5A-5B, the motive force of the motor 38 is transmitted to the rotating air nozzles by way of a dual pulley and belt system 48. The dual pulley and belt system 48 includes a first pulley 44 attached to a drive shaft 40 of the motor 38. A second pulley 46 is attached to the rotational air nozzles. A continuous belt 42 connects the first pulley 44 and the second pulley 46. The belt 42 transfers rotational force from pulley 44 to pulley 46 thereby rotating the air nozzles. As addressed previously, the rotation speed of the nozzles is proportional to cleaning and can be controlled by the pulley system to enhance cleaning on tougher or dirtier surfaces/joints and vice versa.

The motor 28 is connected to the driveshaft 40. Torque is then transferrable from the motor 28 to the nozzle system 24 thus the motor 28 controls the rate of rotation of the shaft 26 and thus nozzles 28. Air circulation in the system 10 is thus controlled directly by the motor 28. As the RPM of the motor 28 is adjusted, so is the rotation of the nozzle system 24. Pulley 44 and pulley 46 may be of a substantially equal diameter. In the embodiment illustrated, pulley 44 is configured to transfer RMPs for rotational speed to pulley 46 such that the pulleys 44 and 46 are configured with different pitch diameters. For example, pulley 46 may have a smaller pitch diameter than pulley 44. Thus, adjusting the RPM of the motor 38 by operation of throttle 36 allows the operator to selectively control the rotational speed of the nozzles 28. The air circulation in the system 10 may then be adjusted according to the needs of the surface to be cleaned.

The system 10 may also incorporate hydro force, that is, the system may also be configured for connection to a local water supply, for example a garden hose, exterior tap or faucet, city water, or even a portable water supply/source where a small amount of water can be incorporated into the compressed air flow to form a hydro force jet for cleaning. The water and compressed air mixture may be ejected from the nozzles 28 as described above with the hydro force control being connected to the air supply or may additionally or alternatively be incorporated into a selectively usable wand terminating in a nozzle. Thus, the user has the option to use only compressed air or to use the combination of water and compressed air. The water incorporated in the compressed air flow may act as a solvent and/or cleaning medium for the surfaces to be cleaned. The amount of water used is sufficiently small enough to significantly reduce the recovery burden of the water. The water remaining on the surface after cleaning is small enough to be effectively removed by the vacuum suction or to evaporate since not enough water was used to develop pooling or puddling during standard cleaning.

When the water and compressed air mixture is incorporated, the compressed air source may be connected via tubing to the handle which is further connected to a barrel 60 which has two inlets 62 and 64, one for connection to first hose for the compressed air source and a second inlet configured to connection to a water source, generally also via connection to a hose. The delivery of the compressed air through the handle and barrel 60 to an outlet hose or tube which terminates in connection to the wand and the nozzles 28 is controlled by a trigger 66 or switch operable from the handle. A valve (not shown) is positioned in the barrel 60 to control the water flow through the handle to the outlet hose or tube and to an exit orifice, or nozzle 28. When the trigger 66 is pulled, compressed air flows through the handle and pushes the valve to open, which allows a flow of water to enter the barrel 60. As the water and compressed air are directed to the barrel, the water and air mix in the barrel and travel through the hose or tube to the nozzle as a jet. Thus, the compressed air is turbulently mixed with a small amount of water to provide a hydro force jet for cleaning.

In one embodiment of the present disclosure, the system 10 further comprises a frame 50. The frame 50 is operably secured to and extends outwardly and upwardly from the base 12. The frame 50 may be of a composite “H” and “A” frame shape. For example, the proximal portion 52 of the frame 50 extends from a secured connection with the base 12 and is substantially “H” shaped 52 for stability and movement with the base 12. The distal portion 54 extends from the “H” shaped section 52 and is substantially “A” shaped 54. Together, the shape of the frame 50 provides an area 56 for the operator during use. The operator may be positioned within the area 56 of the frame 50 during use, allowing the entire system 10 to be supported and portable by a single operator. The frame 12 is then configured to support the system 10 including lengths of the vacuum hose and/or pneumatic air hose between the base and the supply truck or cart. The frame 50 further supports the portability of the entire system. Examples of materials for the frame lengths comprise, but are not limited to, aluminum lengths of tubing various lightweight but durable extrusions.

It should be understand that in any embodiment disclosed herein or combinations of elements described herein to produce a system, the vacuum ports and hoses may be attached to a trailing “A” arm for the operator's ergonomic comfort and ease of use. The vacuum ports and the hoses connected thereto may be attached to a main hose leading to main vacuum source. The compressed air line may also use the trailing “A” aim to route to the cleaner head for the reduce the strain on the operator.

Although the present disclosure has been described with reference to preferred embodiments, workers skilled in the art will recognize that changes may be made in form and detail without departing from the spirit and scope of the disclosure.

1. A pneumatic pavement joint cleaning system comprising:
a wheeled housing comprising at least one wheel having a ground engaging surface;
a rotatable shaft carrying at least one nozzle and secured within the wheeled housing and configured to hover over a ground surface;
a source of compressed gas operably connected to the rotatable shaft for providing pressurized gas flow outwardly through the nozzle;
a vacuum hose connected to an outlet in the housing and the vacuum hose extending from connection with the housing to a vacuum source; and
a motor operably connected to the rotatable shaft and a belt configured to transfer torque from the motor to the rotatable shaft allowing an operator to selectively control the rate of rotation of the shaft and thus the at least one nozzle.

2. The system of claim 1, wherein the ground engaging surface is a surface comprising an array of pavers and joints there between.

3. The cleaning system of claim 1 and further comprising:
a frame operably connected to the wheeled housing and configured to support a length of the at least one vacuum hose extending from the outlet to connection with the vacuum source and further comprising an open space configured for an operator to use during operation of the joint cleaning system.

4. The cleaning system of claim 1, wherein the vacuum hose is a first vacuum hose and the outlet is a first outlet, the system further comprising a second vacuum hose connected to a second outlet of the housing for further providing vacuum removal of debris.

5. The cleaning system of claim 1, and further comprising a handle connected to and extending upwardly from the housing for moving the housing over the paver surface wherein the height and orientation of the handle with respect to the housing is selectively adjustable.

6. The cleaning system of claim 1, and further comprising a frame extending from the housing wherein the frame comprises an open space configured for an operator to be positioned within the frame and behind the housing during operation of the wheeled housing.

7. A frame for a paver joint cleaning system comprising:
a first section having two opposing side rails extending from operable connection with a wheeled housing and the two opposing rails connected by a third rail positioned in a transverse direction such that the first section of the frame is substantially “H” shaped;
a second section extending from the first section where in the second section comprises two opposing side rails which are oriented to converge at terminal ends of each side rail and the side rails connection by a third rail positioned in a transverse direction such that the second section of the frame is substantially “A” shaped; and
wherein the frame comprises an open space configured for an operator to be positioned during operation of the wheeled housing.

8. A method of cleaning a surface area comprised of a plurality of pavers and having at least one paver joint, the method comprising:
providing a housing having a rotatable wand with at least one nozzle configured to direct an airflow from the nozzle;
providing air flow from a pneumatic source to the at least one nozzle;
providing a hose connected to an outlet in the housing and connecting the hose to a vacuum source for creating suction through the outlet;
moving the housing over a selected area comprising the plurality of pavers at least one paver joint and rotating the at least one nozzle providing an outwardly airflow;
adjusting the rotation of the wand within the housing by selectively adjusting the RPM of a motor that is connected to the nozzle by a belt and pulley system configured to transfer torque from the motor to the wand; and
removing debris dislodged by the air flow from the nozzle by positioning the inlet of the vacuum house near the debris.

9. The method of claim 8, wherein moving the housing comprises providing a frame operably connected to the wheeled housing and having an open space for an operator to use during removing debris and the frame configured to support a length of the vacuum hose extending from the inlet to connection with the vacuum source.

10. A pavement joint cleaning system comprising:
a wheeled housing comprising at least one wheel having a ground engaging surface;
a rotatable shaft carrying at least one nozzle and secured within the wheeled housing and configured to hover over a ground surface;
a source of compressed gas operably connected to the rotatable shaft for providing pressurized gas flow outwardly through the nozzle;
a source of liquid operably connected to the operable connection of the source of compressed gas for selectively providing a pressurized mixture of gas and liquid flow outwardly through the nozzle
a vacuum hose having a selectively positionable inlet and the vacuum hose extending to connection with a vacuum source; and
a motor operably connected to the rotatable shaft and a belt configured to transfer torque from the motor to the rotatable shaft allowing an operator to selectively control the rate of rotation of the shaft and thus the at least one nozzle.

11. A method of cleaning a surface area comprised of a plurality of pavers and having at least one paver joint, the method comprising:
providing a housing having a rotatable wand with at least one nozzle configured to direct a jet of a gas and liquid mixture from the nozzle;
providing gas flow from a pneumatic source to the at least one nozzle;
providing liquid flow from a supply source to the at least one nozzle, where in the gas flow and liquid flow turbulently mix while flowing to the nozzle to provide a gas/liquid jet through the nozzle;
providing a hose having an inlet and positioning the inlet neat the housing and connecting the hose to a vacuum source for creating suction through the inlet;
moving the housing over a selected area comprising the plurality of pavers at least one paver joint and rotating the at least one nozzle providing an outwardly airflow;
adjusting the rotation of the wand within the housing by selectively adjusting the RPM of a motor that is connected to the nozzle by a belt and pulley system configured to transfer torque from the motor to the wand; and
removing debris dislodged by the air flow from the nozzle by positioning the inlet of the vacuum house near the debris.
